(19) United States
(12) Patent Application Publication
(10) Pub. No.: US 2013/0030889 A1
(43) Pub. Date: Jan. 31, 2013

(54) Methods and Systems for Providing a Rewards Program

(71) Applicants: Arlyn Samantha Davich, New York, NY (US); Jacob Harry Peters, Boston, MA (US)

(72) Inventors: Arlyn Samantha Davich, New York, NY (US); Jacob Harry Peters, Boston, MA (US)

(73) Assignee: PayPerks, Inc., New York, NY (US)

(21) Appl. No.: 13/557,881

(22) Filed: Jul. 25, 2012

Related U.S. Application Data
(60) Provisional application No. 61/511,925, filed on Jul. 26, 2011.

(51) Int. Cl. G06Q 30/02

(52) U.S. Cl. 705/14.14

(57) ABSTRACT

A system and method for providing a rewards program for a plurality of rewards accounts is disclosed that promote the adoption, retention, and the desirable usage of credit cards, prepaid cards, debit cards, and other transactional products and that induce the development and improvement of consumer behavior through education and rewards. Embodiments of the invention provide a rewards program by associating a financial product with a rewards account of the plurality of rewards accounts and detecting rewardable actions associated with the financial product. Any type of actions may be deemed rewardable actions including the participation in educational programs related to features of the financial product, financial responsibility, health, professional development and others. For completing rewardable actions, participants may be rewarded with points that they may then use to enter into sweepstakes in order to win prizes.

### RELATED APPLICATIONS

This application hereby claims priority to and incorporates by reference U.S. Provisional Application Ser. No. 61/511,925 filed on Jul. 26, 2011.

### FIELD OF THE INVENTION

The present invention relates to rewards programs that promote the adoption, retention, and the desirable usage of credit cards, prepaid cards, debit cards, and other transactional payments products and induces the development and improvement of consumer behavior through education and rewards.

### BACKGROUND OF THE INVENTION

The use of credit cards, charge cards, debit cards, ATM cards, prepaid cards (also known as prepaid debit cards or stored value cards), and other types of financial transaction cards have become common among consumers throughout the world. Many consumers carry two or more of these financial products at all times. To make their products more desirable to consumers, card issuers typically compete with one another by varying the interest rates, fees, and rewards. For example, card issuers may grant consumers a low interest rate or charge low fees for a promotional period. After the promotional period ends, the interest rate or fees that the consumer would incur increases to a higher rate or amount. Other card issuers may incentivize consumers with rewards. These loyalty programs may arise from a relationship between the credit card issuer and a merchant. For example, consumers who spend money using these financial products may gain points that may be redeemed for frequent flier miles, which may then be used to purchase airline tickets. Consumers of other cards may redeem their points for merchandise. Some card issuers will also offer the consumer the opportunity to receive a percentage of the amount he or she spent in the form of “cash back.”

While the reward programs offer many benefits in the form of prizes and cash, they often fail to attract low-income to middle-income consumers. These classes of consumers often have trouble earning points and rewards under current rewards programs because of their lower income. Indeed, they are at an inherent disadvantage by participating in a rewards program that is based solely or substantially on the volume of spending. Even if card providers offer merchandise or prizes that are within the spending habits of consumers, these prizes do little to incentivize these consumers to use a particular financial product.

For those consumers who do begin to use these financial products, many do so without full knowledge of the risks and benefits of these products. For example, new card holders are often unaware of the many finance management and credit protection features that are available, including the ability to check balances, pay bills, and replace lost or stolen cards. In addition, many of these same card holders are not aware of hidden fees or increasing interest rates that one would incur, such as the fees incurred in signature-based transactions versus those incurred in PIN-based point-of-sale transactions. These same customers are also unaware of the number and type of transactions that may be completed without incurring any fees. Furthermore, these offers of low interest rates, low fees, and prizes, often lead these consumers to spend beyond their limits, thereby creating long-term financial issues.

Indeed, there are few, if any, effective methods to educate members of the lower and middle class aspects of not only personal financing, but also personal health, professional development and other important topics, despite the increased accessibility of information via the Internet and other public sources. Making the information available alone, without some additional motivation, is simply not sufficient to encourage self-teaching and behavioral improvement.

Accordingly, there is a need for methods and systems for an educational rewards program that promotes the adoption, retention, and the desirable usage of credit cards, prepaid cards, debit cards, and the like. At the same time, solutions are also needed for educational rewards programs that educate the public to any number of important topics while encouraging participants to take part in or perform responsible actions related to their personal financing, their health, and other important aspects.

### SUMMARY OF THE INVENTION

A system for providing a rewards program for a plurality of rewards accounts is disclosed that contains a processor coupled to a storage device, a user interface, and a communication network. The processor may execute instructions that associate a financial product with a rewards account and may do so, in one embodiment, based on one or more activation codes. A rewardable action may be received that is associated with the financial product (e.g., a debit card, a credit card, or a prepaid card). In response, the units of chance may be associated with the rewards accounts in response. Further, at least one sweepstakes drawing that has been established may be executed and a winning unit of chance from a pool of units of chance may be selected. A prize may then be rewarded to the rewards account associated with the winning unit of chance.

In a preferred embodiment, the rewardable action may be a transaction that is completed using one or more financial products. One type of rewardable actions may be the participation in an educational program, which may include, for example, programs that relate to or teach: features of the financial product; features of the rewards program; financial responsibility; asset building; shopping; nutrition; professional development; family management; real estate, and others. Furthermore, the educational program may be made up of text, illustrated art, video clips, video conferencing, teleconferencing, or an audiocast.

Other examples of rewardable actions may include: depositing money into an account associated with the financial product; reactivating the rewards account; keeping the rewards account active for an extended period of time; making a point of sale transaction with the financial product; paying a bill with the financial product; purchasing an essential item with the financial product; completing a sales transaction with a new retailer, location or source with the financial product; completing a transaction with a predetermined merchant with the financial product; and making a signature-based transaction with the financial product. In response to a second rewardable action, the system may be further configured to associate a second one or more units of chance with the rewards account. The rewardable action may include the completion of a questionnaire that is related to the educational program provided or may be a rewardable action that is described by the educational program. In one embodiment, the system may automatically detect the rewardable action at a point of sale system or a financial services system. In one embodiment, the system may further be configured to un-associate one or more units of chance with the one or more rewards accounts based on negative actions taken by the participant of the rewards account.

In another aspect of the present invention, a method for providing a rewards program for a plurality of rewards accounts is disclosed. The method includes the step of associating a financial product with a rewards account of the plurality of rewards accounts and establishing at least one sweepstakes drawing. Furthermore, a rewardable action may be received that is associated with the financial product associated with the rewards account. In response, one or more units of chance may be associated with the rewards account. The method further includes the step of executing at least one sweepstakes drawing by selecting at least one winning unit of chance from a pool of units of chances associated with the plurality of rewards accounts. Finally, a prize may be provided to the rewards account that is associated with the at least one winning unit of chance.

### BRIEF DESCRIPTION OF DRAWINGS

The present invention will now be described, by way of example only, with reference to the accompanying Figures, in which:

FIG. 1 depicts a flowchart illustrating a method for providing a rewards program for financial products in accordance with an embodiment of the present invention.

FIG. 2 illustrates the working environment of a rewards management system in accordance with an embodiment of the present invention.

FIG. 3 depicts a rewards management system in accordance with an embodiment of the present invention.

FIG. 4 illustrates a registration user interface in accordance with an embodiment of the present invention.

FIG. 5 shows a rewards account dashboard in accordance with an embodiment of the present invention.

FIG. 6 depicts an educational program user interface in accordance with an embodiment of the present invention.

FIG. 7 illustrates an exemplary user interface of the educational program provided to the participant in accordance with an embodiment of the present invention.

FIGS. 8A-8B depict questionnaire user interfaces in accordance with an embodiment of the present invention.

FIG. 9 shows a savings calculator in accordance with an embodiment of the present invention.

FIG. 10 depicts a flowchart of user-interfaces provided to a participant participating in a sweepstake in accordance with an embodiment of the present invention.

The following describes in detail various embodiments of the present invention. One of ordinary skill in the art would understand that standard programming and engineering techniques may be used to produce such embodiments including software, firmware, hardware, or any combination thereof to implement the disclosed subject matter. The attached Figures depict exemplary embodiments and are meant to be understood in view of the details disclosed herein.

### DETAILED DESCRIPTION OF THE INVENTION

Embodiments of the present invention are directed systems and methods for providing a rewards program for financial products. A financial product, for example, may be a credit card, charge card, debit card, ATM card, prepaid card (also known as prepaid debit cards or stored value cards), each of which may be general use, “open loop”, private label (private network), or any other forms. Other examples of financial products may include mobile wallets, electronic fund accounts, app-based transactional accounts, remittance payments and coupons, or even prepaid-cell phone plans. The use of the term “financial product” herein should not be read to be limited to these exemplary forms of financial products. Indeed, embodiments of the present invention may be configured to provide a rewards program in association with any type of financial transactions, including those that involve any types of financial products. Embodiments may also be integrated with any transactional accounts and programs to provide a rewards program to participants.

The uses of terms such as, “financial product,” “card,” or others herein should be given the broadest reasonable interpretation and should not be interpreted as limiting in anyway. For example, the terms, “financial product” and “card” may be used interchangeably hereinafter to refer generally to a financial instrument and the use of a one particular term over another is meant to be exemplary only.

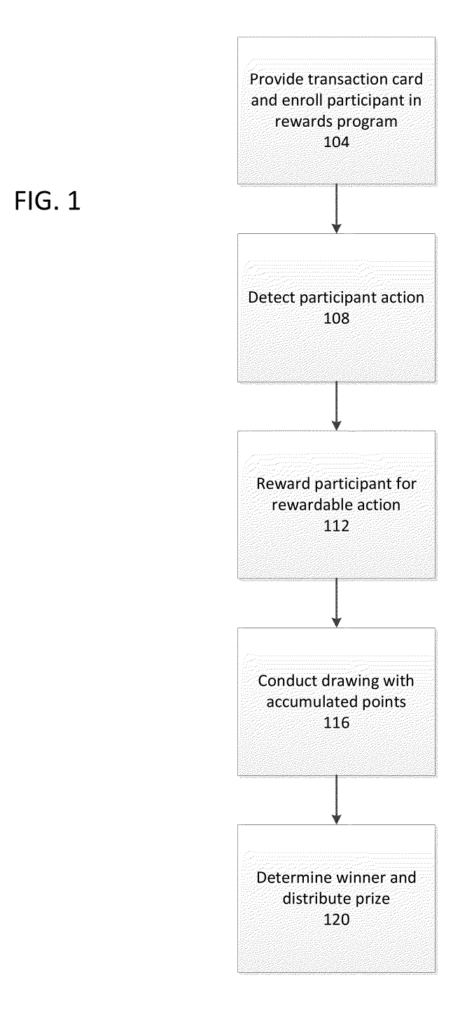

FIG. 1 depicts a flowchart illustrating a method for providing a rewards program for financial products in accordance with an embodiment of the present invention. At 104, a rewards program participant may be provided with or be given access to a financial product, or a card, as used interchangeably herein. For example, a participant may be mailed a prepaid debit card that may be used at any point of sale, ATMs and banks. In addition, the participant may be enrolled in a rewards program and the participant's financial product may be associated with a rewards account for the participant. In one embodiment, financial accounts associated with the financial product may be automatically associated with a rewards account of the participant. In preferred embodiments, rewards programs may be provided to unbanked and underbanked consumers, although, in other embodiments, the class of participants need not be limited to these particular consumers but may be any other classes of consumers.

At 108, a participant action may be performed and detected. The participant may perform, for example, transaction-related actions available to financial product holders. For instance, a participant may swipe the transaction card at a point of sale to purchase items or complete a remittance payment to relatives in a home country. The participant may also perform account-related actions, such as linking his or her transaction card with a checking account, depositing money into an account, or simply checking an account balance. Various other transactions and account-related actions may also be performed.

In addition to these participant actions, the participant may also take part in an educational program. For example, a participant may log into the rewards program's website to select and view a lesson from a number of subjects or curriculums. In a preferred embodiment, educational programs may teach participants aspects and features of the financial product and the rewards program. Further, participants receive lessons related to aspects of financial responsibility, including how to save money, avoid transaction fees, and to use the transaction card responsibly. Other educational programs may include those that teach aspects of personal health, career and professional development, real estate, parenting/childcare, and others. Educational programs may also teach participants various aspects of their financial accounts. As one example of an educational program, the participant may view an educational video that teaches the participant the benefits of linking his or her transaction card with a checking account. The participant may also be asked to take a quiz that tests the participant's knowledge after viewing the program as a means to encourage sustained knowledge and actual use of the features taught. In one embodiment, the educational program may be in the form of a game that allows the participant to learn important aspects of financial products while playing the game.

At 112, the participant may be rewarded where the participant action detected at 108 is rewardable. In the preferred embodiments, participants may be rewarded for using the transaction card at point of sales, for reviewing and taking part in educational programs, and for taking questionnaires relating to the programs afterwards. Furthermore, participants may be rewarded for using the features taught in these educational programs. As such, embodiments of the presently disclosed systems and methods may encourage participants to learn important aspects of personal finance, personal health, and professional development, and other important topics while, at the same time, further encourage participants to apply the knowledge learned. For example, a participant may not only be rewarded for learning about the benefits of linking his or her rewards account with additional bank accounts, but may also be rewarded for linking his or her savings account to the rewards program. Embodiments may also encourage participants to learn various aspects of personal finance, features of the financial product, tools provided by the financial institution, as well as various other aspects and topics as a transparent means to demonstrate a financial institution's (or a participating organization's) efforts to meet its fiduciary duty(ies), as may be required by regulations and other applicable laws.

In turn, participants may receive units of chances (each a “point”) for performing such rewardable actions. The term “point” is used herein for convenience of discussion, but a person of ordinary skill would readily appreciate that units of rewards or chances could be characterized in different manners without departing from the spirit and scope of the invention.

The number of points that a participant may receive may vary from action to action, and further vary from rewards program to rewards program, as may be configurable as necessary to meet the goals and policies of a rewards program. Rather than rewarding solely on the volume of spending, as in traditional rewards programs, embodiments of the present invention may reward points to participants for any or all actions. Furthermore, points may be awarded for actions that are more beneficial to participants (e.g., establishing a savings account versus withdrawing money from an ATM) and for actions that are more difficult or rarely taken by participants of the rewards programs (e.g., using features rarely used). Points may also be determined based on any number of other factors or may be distributed at random.

Each point may represent a chance or entry to win prizes in a drawing. At 116, a drawing, which may take place at predetermined drawing periods (e.g., weekly, bi-weekly, or monthly), is performed to determine whether participants receive a prize. In one embodiment, all of the points that participants have accumulated during a sweepstakes period may be eligible for play in the sweepstake. One or more sweepstakes entry may be selected to determine the winner(s). Various forms of sweepstake selection algorithms and prize distribution structure may be utilized.

The participant's chances of winning with his or her total accumulated points may depend on the total number of points at play in the particular sweepstakes. Thus, as more and more participants play and the total number of points at play increase, the more difficult it may be for any one particular participant to win. Of course, by rewarding participants with points for any number of actions, even those that are basic or easily performed, participants may easily accumulate more points in order to increase his or her chances of winning in each sweepstakes. Some points may be earned passively. For example, if a cardholder enrolls on a particular card, they may automatically get points each month they have that card. At the same time, participants are encouraged to perform more rewarding actions to receive more points in exchange.

In at least one embodiment, a rewards program provider may increase (or decrease) participants' chances of winning a prize, including on a participant-by-participant basis, in order promote participation in the sweepstakes and the rewards program. The determination of whether the participant wins a prize may also be determined independent of other participants and may be determined at random for each participant. In many cases, participants may win prizes without having to ever spend money and, in many instances, may even win prizes that greatly exceed the value that the participant has spent using the card or the issuer has earned by virtue of the consumer's activity.

At 120, a participant is determined to be a winner and is provided with a prize. The prize may be cash, credit, merchandise, airline miles, and other rewards or bonuses. Where the prize is cash or credit, the participant's account may be credited with the rewards amount directly and/or instantly.

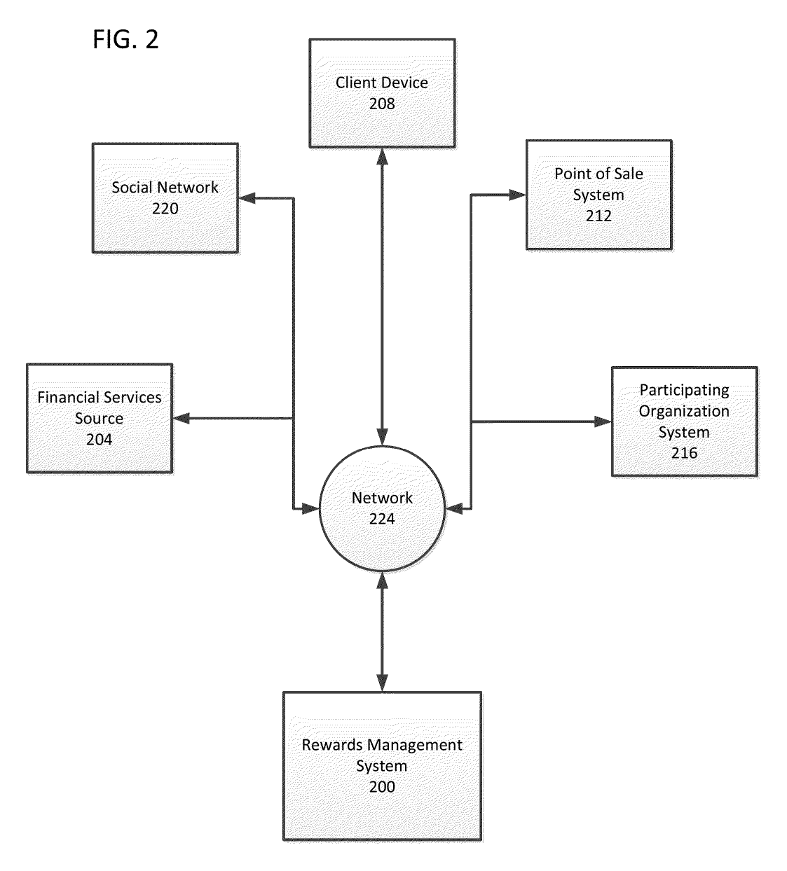

Referring now to FIG. 2, an embodiment of the presently disclosed invention is depicted in the form of the rewards management system 200. The rewards management system 200 is connected to network 224, which allows the system 200 to further connect to a plurality of devices and systems including financial services source 204, client device 208, point of sale system (POS) 212, participating organization system 216, and social network 224. Each of these devices may communicate with the other devices and systems connected to the network 224, which may be made up of a number of networks including the Internet. Although not depicted, there may be an ATM or other regional network of ATM type terminals, a national interchange network (e.g., MasterCard, VISA, or American Express) for receiving and processing transaction requests, and regional interchange networks (e.g., PLUS, MAC, Cirrus, or Maestro), card processors (for acquiring and routing POS transactions as appropriate), merchants banks, and issuing banks, and systems or portions of such systems thereat, as well understood in the art.

In operation, the rewards management system 200 has the capability to manage participants' rewards accounts. A participating organization system 216 may communicate with the rewards management system and/or the financial services source to configure a rewards program for a number of participants.

A participating organization system 216 may be, for example, a retailer that has chosen to pay its employees through prepaid debit cards and may want to encourage responsible financial behavior through the establishment and use of a rewards program as disclosed herein. Indeed, a participating organization may be any organization, company, or merely a group of participants who would like to participate in a rewards program. Embodiments of the present invention may be configured to provide a rewards program for any number of participating organizations. The rewards management system 200 may provide and manage rewards program for each organization or a number of organizations. For example, related companies may participate in a single rewards program, allowing all of the employees across all of the related organizations to participate. As a result, the rewards management system 200 may automatically connect with the participating organization systems to perform the operations described herein. Through this feature, the embodiments of the present invention may provide rewards program for any number of organizations, even to those organizations that may be competitors within the same industry. There may be a number of rewards programs for each sets of organization. Further, in one embodiment, universal and/or regional rewards programs may also be provided.

Participants may use a client device 208, which may be any computing device such as a computer, laptop, mobile phone, or tablet, to access the rewards management system 200 via network 224, and to sign up for a rewards program that has been established. The rewards management system 200 may offer a rewards program for any number and type of financial products including credit cards, debit cards, prepaid cards, remittance transaction/accounts, pre-paid phone accounts, mobile wallets, and various others, as previously described. Prepaid cards may be general purpose reloadable cards, payroll cards, public sector benefits cards, or others. These cards may also be domestic or international cards and may work with any number of currencies across any number of countries or regions.

These financial products may be issued by a financial services source 204, which may include banks, lenders, companies, or even retail stores. The financial services source 204 may manage the financial products after they are activated and are in use. Thus, a financial services source 204 may receive, process, and complete transactions and transaction-related requests. The financial services source 204 may process transactions that are received at a point of sale system 212, which may be any system capable of receiving and processing transaction requests at points of sale, such as a network-connected register, a mobile device capable of reading transaction card information, and other systems utilized in the art. As one example, a participant may pay for her groceries by swiping a prepaid debit card that is associated with a rewards program at the register. The financial services source 204 may automatically detect and approve the transaction by communicating with the point of sale system 212 at the grocery store. In turn, the financial services source 204 may communicate the grocery store transaction information to the rewards management system 200 to record the transaction. Embodiments of the rewards management system 200, in response, may award the participant with a number of rewards points.

Embodiments of the present invention may be configured to operate with any number of financial service sources to perform the operations described herein. Thus, the rewards management system 200 may communicate with a plurality of financial service sources 216, and 216′ (not shown) for each rewards program. A rewards management system 200 may provide a rewards program in association with a financial services source alone, even without any participating organization systems 216.

The financial services source 204 may further manage the financial accounts related to the financial product, and in one embodiment, may also manage the rewards program provided by the rewards management system 200. Note that in various embodiments, a card issuer system (not shown) may be an entirely separate entity than the financial services source 204, which may create and issue the transaction cards and the financial services source 204 may manage the cards and associated accounts after issuance.

The rewards management system 200 may be further connected to a plurality of partner systems (not shown). As discussed in other portions of this disclosure, embodiments of the present invention may be configured to provide participants with rewardable tasks, surveys and information associated with various third-party partners (e.g., sponsors, advertisers, survey analyzers, educational program providers). Participants may be provided points for performing partner-defined tasks, such as visiting a partner's bank to open a savings account, purchasing a partner's product, or even visiting a partner's website. Further, rewards management system 200 may provide partner systems with information related to participant actions, including those actions that are rewardable, survey answers, and other participant behavior. The third party system, thus, may utilize such information to improve rewardable tasks, advertising targeting, and educational programs. In one embodiment, consumers may configure what information is provided to the third parties, including what personal information and actions may be provided to such parties.

While FIG. 2 depicts a rewards management system 200 that is separate from the financial services source 204, in certain embodiments of the present invention, the rewards management system 200 may be integrated with a financial services source 204. The rewards management system 200 may also be configured to cause and/or to facilitate the integration of a rewards program with a financial services source 204 in accordance with an embodiment of the present invention. The rewards management system 200 may automatically and dynamically deliver and/or install engines, databases, and other components at the one or more financial services sources 204, 204′, as may be necessary to operate a rewards program, including, but not limited to, those engines and databases discussed herein.

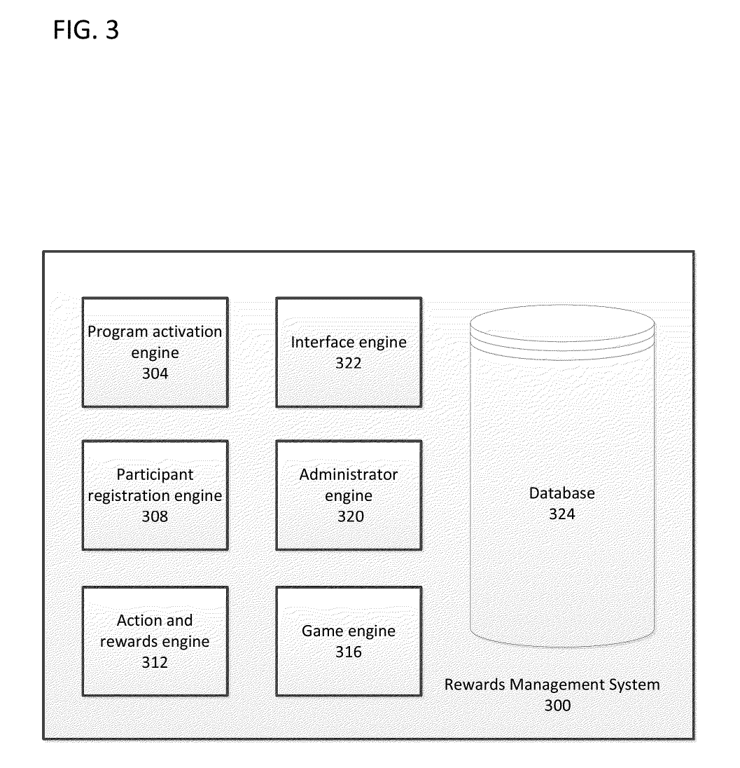

FIG. 3 depicts a rewards management system 300 in accordance with an embodiment of the present invention. As seen, the rewards management system 300 may include a program activation engine 304, a participant registration engine 308, an action and reward engine 312, a game engine 316, an administrator engine 320, interface engine 322, and a database 324.

The program activation engine 304 may be configured to create and/or activate a rewards program according to instructions received from a financial services source, a participating organization system, a client device, or from various other sources. The participating organization may communicate (e.g., via a participating organization system 216 of FIG. 2) with a financial service source to configure a prepaid debit card. A participating organization may also work directly with employees of the financial service source to generate a transaction account and an associated prepaid debit card for each employee. In response, the program activation engine 304 may receive and process a request from a financial services source to start a rewards program. In some embodiments in which the rewards program is integrated with a financial services source, no additional rewards accounts are created. Instead, rewards data may be stored within each transaction account at a transaction accounts database of a financial services source. Other methods of establishing transaction accounts and/or transaction cards known in the art may also be utilized.

Where a participating organization has requested the creation of a rewards program for its customers, the participating organization system 316 may transmit a rewards program request, which may contain: data identifying attributes of the financial product (e.g., transaction card), the associated financial network, the transaction card issuer (if applicable), and the transactions accounts. In one embodiment, the rewards program request may further include data describing the rewards system, the rewardable actions, the sweepstakes and/or game, and other attributes discussed in connection with various embodiments of the present invention disclosed herein. The program activation engine 304 may process the request information to automatically activate the program for use and may store the request data and the data of the established rewards program at the database 324. The program activation engine 304 may preconfigure and prepare rewards accounts according to each corresponding transaction account. Thus, the database 324 may associate each rewards account with a transaction account of the financial services source, and may include any additional information to identify the account and the financial services source. In another embodiment, such data, or portions thereof, may be stored at the financial services source.

The program activation engine 304 may further generate a plurality of activation codes for each rewards account. The program activation engine 304 may communicate the listing of activation codes back to the financial services source for distribution to the employer organization or to the participating organization system. In one embodiment, the program activation engine 304 may automatically generate and transmit encrypted emails containing the activation code to each employee email account. The rewards management system 300 may also automatically generate and print tickets containing the activation code, which may be distributed by the participating organization.

The participant registration engine 308 may be configured to facilitate the registration of one or more participants in a rewards program. The participants may sign up for the rewards program by way of an activation code previously provided to the participant. For example, an employer who chooses to pay its employees through prepaid debit cards may provide the employee with an activation code. As another example, retail stores or general purpose reloadable card issuers/program managers that sell transaction cards at retail stores may provide participants with activation codes as a promotion for purchasing a prepaid debit card or for signing up for the store's credit card, for example. Each activation code may be associated with a financial product and/or the associated account. When the employee's prepaid debit card is activated, an activation code may be generated automatically or associated with the prepaid debit card account managed by a financial services source.

In at least one embodiment, each activation code may operate merely as a means for access to the registration of a rewards account. Thus in such embodiments, activation codes, when generated by the rewards management system 300, may not be pre-associated with any particular transaction or rewards account. A set of activation codes for a set of employees, for instance, may or may not be unique. For instance, each employee of one organization may receive the same activation code that he or she may use to register a rewards account. Upon activation of the code, the participant may be asked to enter registration information that may include information of the participant's transaction account, financial services source, participating employer system, personal information and various other information. In yet another embodiment, participants may not need an activation code to sign up for the rewards program at all. The participant may instead sign up simply by creating a new account. This may require the participant to enter his financial product accounts information and/or his personal information, which may include any combination of his name, social security number, date of birth, full or partial address, employee identification, and other information. As an incentive to sign up, participants may automatically receive a predetermined number of points after signing up for an account.

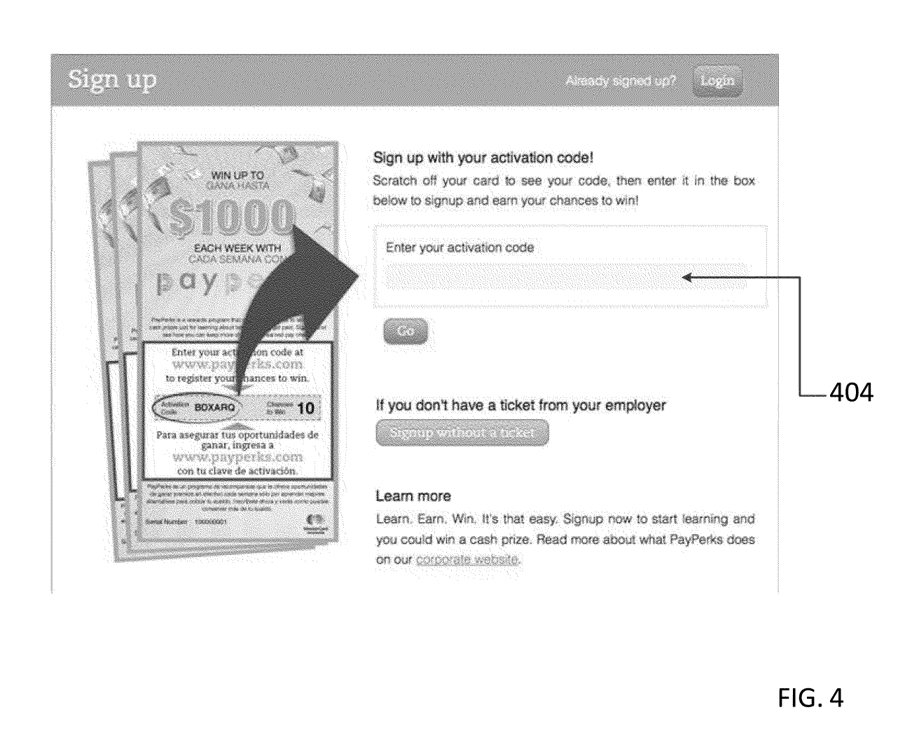

An exemplary user interface is shown in FIG. 4, in accordance with an embodiment of the present invention. As seen, participants may sign up for an account by entering the activation code provided on a ticket at entry 404. Upon the submission of the activation code, which may be a series of letters, symbols and numbers, the participant's account is activated. As also seen in FIG. 4, an activation code is not necessarily required to sign up. Instead, a participant may simply bypass the activation code requirement to register a rewards account with the rewards management system 300 by selecting the register button.

Upon the activation of a participant's account, the rewards management system 300, and more specifically, the registration engine 308, may automatically connect to a financial services source and/or the participating transaction system to complete the activation of the rewards account. In one embodiment, the registration engine 308 may download the transactions data of the financial account associated with the participant and store the participant account information for storage at database 320. The participant's name, address, account number, and recent transactions may be retrieved automatically from any number of sources. In another embodiment, minimum transaction information may be retrieved and stored at database 320 in order protect the privacy of the participants. In at least one embodiment, participant account information and transaction data may also be collected via screen scraping. For example, a participant may be provided a login screen from which he or she may access his or her financial services source account website. After login, the rewards management system may automatically scrape transactional and participant account data using screen scraping methods well known in the art. The collected data may then be stored at the database of the rewards management system accordingly.

The registration engine 308 may analyze the financial account data retrieved to validate the account and to further ensure that the transaction account belongs to the participant and not to another person. Further, registration engine 308 may validate the account to determine whether such accounts may be linked with the rewards program at all. In certain instances, a financial account may not be supported by the rewards program or associated transaction card and therefore cannot be linked. Such validation steps may also be taken prior to the downloading of any transaction data. In addition, the registration engine 308 may analyze the transaction data to determine whether the participant qualifies for points. For example, participants may receive points based on recent financial transactions that are rewardable or based on an attribute or the status of a financial account.

The registration engine 308 may further notify the participating organization system that a participant's activation code and the rewards account of an employee has been activated. Other account information may be provided to the participating organization system. In one embodiment, the rewards account may not be fully activated or utilized by a participant until an administrator at the financial services source has approved the activation of the account. This feature may allow employers to manage the employees that are allowed to participate in the rewards program.

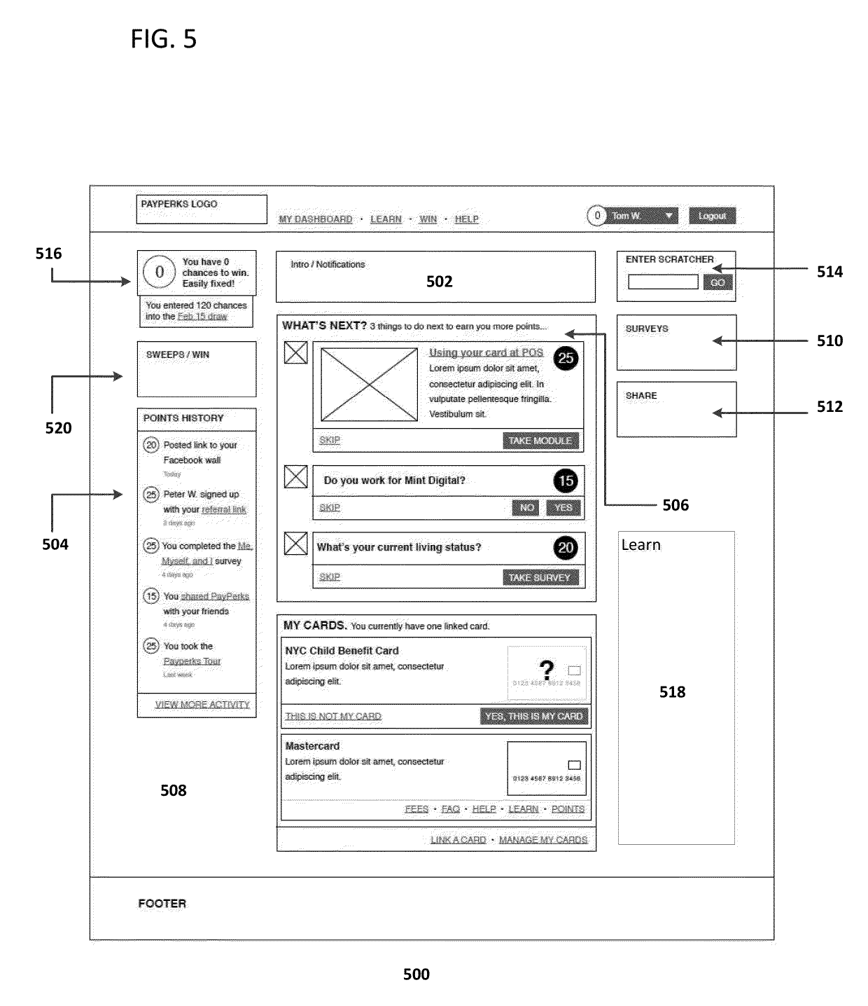

Once a rewards account has been activated, the participant may have access to his or her rewards account. A participant, for example, may utilize a client device (e.g., his or her smartphone, laptop, tablet, or even an ATM) to access a web site or interface module associated with the rewards managements system 300. Upon registration, the participant may use a participant username and password to access his or her rewards account. Once logged in, the participant may be shown an accounts dashboard user interface 500 generated by the interface engine shown in FIG. 5. The rewards dashboard 500 may contain a plurality of panels, including notification panel 502, activity history panel 504, featured rewards panel 506, my cards panel 508, survey panel 510, share panel 512, and scratcher panel 514, current points total panel 516, and education panel 518, sweepstakes results panel 520. The participant may further be given access to a plurality of other user interfaces including an account options page, an about page, and a help page.

The notification panel 502 operates as a central notification center through which the participant may be given the latest news about the rewards program, the organization, the account, and other sources. For example, new features or points newly accumulated since the participant's last visit to the dashboard 500 may be shown within this notification panel 502. Furthermore, the activity history panel 504 provides the participant with a view of the total number of points that the participant has accumulated recently and may describe the actions that allowed the participant to earn such points. For example, an entry in the activity history panel 504 may indicate that the participant has received 20 points for posting a link related to the rewards program to the participant's Facebook and Twitter account. Other activity history information may be shown including sweepstakes that the participant has entered into, changes to account information, the linking of transaction cards, the participation in an education program, as well as other types of information. In one embodiment, a participant may filter and customize what information in shown in the activity history panel 504 based on any attributes.

In addition, the featured rewards panel 506 may be configured to display to the participant featured rewardable actions. Potential rewardable actions may be featured by an organization, a financial service source, or a partner (e.g., sponsor). The rewardable actions that are shown may be actions that benefit participants, the organization, and/or the financial service source. Actions that are listed may, for example, be part of efforts by an organization and/or financial service source to meet its fiduciary duties in informing its employees or customers. In another embodiment, this panel 506 may feature actions that would earn the participants the most points. In one preferred embodiment, the rewards management system may be configured to provide and display sponsored or branded content. Participants may be provided educational programs or actions that are related to a sponsor product or provide links to sponsor websites or information. Sponsors may further feature surveys and other rewardable actions from which the participant may take part in. For instance, a participant may be given points for visiting a website of a sponsor and participating in an educational program thereat. Or, PayPerks could give users points for using a coupon for a particular product in store. Users may be offered different education and rewards as a result of a variety of factors. Therefore, embodiments of the present invention may allow third parties such as manufacturers, retailers, and even advertisers to target consumers and those who otherwise may utilize their products and may operate independently from financial service sources or participating organizations.

In yet another embodiment, the rewardable actions that are featured on the featured rewards panel 506 may be customized according to each participant, according to the interests of the participants, rewards history, action history, account type, and/or other data. The rewardable actions that are displayed to the user may be actions that are similar to those that the participant has performed in the past and/or received points for in the past. Rewardable actions that are shown may also be customized based on survey answers that the participant has entered in the past. Furthermore, rewardable actions may be targeted towards participants based on his or her gender, age, race, relationship status, financial accounts types and other attributes.

The my cards panel 508 may display to the participant the participant's currently linked products and may provide participants with the ability to add additional products to the rewards program. Detected products associated with the participant may be suggested to the participant in this my card panel 508, thereby allowing the participant to quickly and easily link cards with the participant's rewards account. Thus, in at least one embodiment of the present invention, the rewards management system may accumulate account and participant data not just from transaction account(s) of one particular financial services source, but may gather additional data from any number of sources including other financial services sources (e.g., sources of savings accounts, 401K, bonds, investment accounts, etc.), social networks, and various other information sources.

The survey panel 510 allows participants to select and take part in various surveys that are available. The surveys may ask participants for additional participant information (e.g., describe your current living status survey), participant's habits or preferences (e.g., describe your dining out habits), or participant interests (e.g., would you sign up for a debit card with 0% APR for 24 months). Such information may be utilized by the rewards management system to customize the types of rewardable actions and rewards that are provided and/or made available to participants. Thus, after a participant completes a survey indicating that the participant is interested in saving to buy a house, a number of rewardable actions may be customized for that particular participant, rewarding the participant for taking part in educational programs that teach the participant the best way to save money for a house, the steps necessary to acquire a home loan, and how to improve one's credit, for example. Similarly, participants that indicate that they spend a lot of time going to restaurants but want to save more money, may be rewarded with more points for buying groceries while rewarded with less points for dining out.

Participants' educational material may also be customized based on answers to surveys. A participant who has indicated they would like to buy a car may be provided an educational program about the steps should be taken or information that should be considered when buying a car. In one embodiment, survey results may be analyzed in aggregate by the processor of the rewards management system to create customer insights that might benefit financial service organizations or partners. For example, if the rewards management system determines that participants are increasingly interested in purchasing a car, the system may leverage this insight to a variety of ends. For example, additional educational programs may be created and provided to participants concerning a popular subject. Similarly, more actions related to interested topics may be rewardable.

The share panel 512 allows participants to quickly and easily share links and information about his or her actions on any number of social networks such as Facebook, Twitter, Foursquare, LinkedIn and so on. In one embodiment, the participant may utilize the share panel 512 to link the participant's reward account with any social network. In doing so, participant actions may be automatically integrated with the rewards management system and additional rewardable actions may be activated for redemption by participants. For example, by linking an account with Foursquare social network, a participant may automatically receive points each time the he or she “checks-in” into a financial services source, such as the bank associated with a prepaid debit card. Where the rewards program encourages personal health, for example, the participant may be rewarded points for checking into a healthy restaurant. Thus, any number of social networks and third party systems may be linked with the rewards management system to provide further mechanisms in which participants may receive points and, therefore, further encourage smart and beneficial behavior in accordance with the goals or policies of the rewards program.

In at least one embodiment of the present invention, participants may receive various forms of social currency from which they may utilize in association with social networks. For example, each participant to a rewards program may be ranked against one another and may be provided social points (or other forms of social currencies) for social activities, such as sharing on a social network, sending social network messages regarding the rewards program, or visiting a sponsor website. In one embodiment, participants may receive social points for various actions that are distinct from the actions that are rewardable for sweepstakes points.

Participants may be further associated with any number of social classes or groups based on the number of social points that the participant has accumulated. Each participant may then share at social networks his or her associated social class or group in the form of a badge, icon, or emoticon. For instance, a top 50 social points accumulator for a particular week may be given a gold star. Whenever he or she shares with a social network, the participant's gold star may be shown along with the participant's post. Furthermore, various other types of social-based prizes may be provided to participants (e.g., stars, characters, trophies). In addition, other types of individual or class ranking or differentiators may be utilized to determine social classes or groups. In one embodiment, the participant may further print out or be provided physical representation of his or her social class, such as a printed card showing the participant's group or class. A rewards participant card, for example, may be provided to the participant. In an embodiment, participants may use such cards to identify the participant at real world locations to perform actions disclosed in other portions of this disclosure. For example, a participating partner may scan a two dimensional bar code also on the printed card when rewarding participants with points for rewardable actions.

The scratcher panel 514 allows participants to enter additional activation codes. In one embodiment, employers may provide additional activation codes to employees each month rather than directly depositing the amount to an account. The participant, thus, may use this scratcher panel 514 after receiving a scratcher card from his or her employer and may enter the code to add funds to the participant's pre-paid debit card. Employers may also provide additional activation codes as a reward or bonus for exceptional performance or rewardable achievements. The activation codes do not have to provide the participant with additional funds but may grant participants bonus points to play in a sweepstakes. Thus, this feature allows employers to reward their employees through non-monetary means as well.

In various embodiments, additional scratcher cards may be received from various other sources including retail stores or banks. For instance, a bank can reward participants with additional points for visiting the bank. The scratcher card may also be used as proof that the participant has completed a particular rewardable task, such as a reward for having visited a bank to have a discussion with an associate about a savings account. Participants may also receive points for purchasing sponsored brand of vitamins at a health nutrition store; visiting the doctor for a physical; spending less than $50 on a weekly grocery trip; and visiting a certified public accountant (CPA) to discuss about developing a retirement portfolio. Indeed, in various embodiments of the present invention, participants may be rewarded for visiting, completing a task at, or otherwise taking action with regard to any partner, which may be any organization that is participating in providing participants with rewards for rewardable actions. Embodiments, thus, may leverage scratch cards (as well as marketing materials) to drive participants to participate in the rewards program, serve as a reminder to revisit the system from time-to-time to manage rewards points), as well as serve as a reward to users who complete any number of real life actions.

Furthermore, the current points total panel 516 may provide the participant's total number of points that the participant currently has and may further show the number of points that was previously accumulated and/or total points that were entered into the last sweepstakes. The panel 516 may further show the participant's probability in winning a particular sweepstake and the total number of points that are active in the current drawing. In a preferred embodiment, the number of points a participant has earned and his or her possible winnings is always displayed on the user interfaces provided to participants, regardless of the information the participant is viewing. Thus, as shown in FIG. 5, a participant may view, through the current points total panel 516, that he or she has entered 120 chances to win in the February 15 drawing.

Furthermore, sweepstake results panel 520 may display to the participant the results of previous sweepstakes including whether the participant has won. Thus, this panel 520 may be utilized as a notification center for the participants when he or she wins a prize from a sweepstake.

In addition, participants may have access to a testimonial panel (not shown), which may provide participant testimonial of the rewards program(s), rewardable actions, sweepstakes, or other features of the rewards program(s). For instance, a participant testimony may describe how it is easy to receive points even for sending a remittance payment to his relatives. Testimonials may also be provided to potential participants. In a preferred embodiment, users may receive points for providing testimony.

When a participant connects to the rewards management system, he or she may also participate in any number of educational programs. The participant may access a plurality of educational modules that may teach the participant various aspects of financial management, asset building, personal health, professional development and various other topics. Examples of financial management or asset building educational programs may include programs that teach participants about: the benefits of having a debit, credit, prepaid, or other card; managing one's finances with the card; how to load money into the account associated with the card; how to use the card at a point of sale; what happens if one loses the card; and how a prepaid card may help with building one's assets. Similarly, asset management educational programs may be provided to participants, which may, for example, be programs that teach participants: basics of investment and investment products; how to manage a financial portfolio; how to save; what to know about retirement; how to build a retirement portfolio; and others.

Further, participants may be provided with programs that teach participants about personal health, including programs that teach participants: aspects of the Food and Drug Administration (FDA)'s Food Pyramid; the effect of saturated fat and cholesterol intake; the benefits of vegetables and daily vitamins; the need for daily exercise and a balance diet; how to perform the Heimlich maneuver; when to see the doctor; oral hygiene basics; detecting signs of pregnancy; and other aspects that may be deemed to be important or useful for individuals and families. In addition, participants may have access to programs that teach participants aspects of career and professional development, such as programs that describe to participants: important features of a resume; considerations in applying for a school loan; how to prepare for an interview; the need for retirement savings and retirement related funds; available governmental professional and education related-relief programs; considerations in returning to school; and others. Similarly, shopping related educational programs may be provided that teaches various aspects of smart shopping. These programs may, for example, teach participants: how to save using Internet; the best time to purchase different types of merchandise; the best methods to pay for products; the basics of loan programs; and others. Other educational modules may further provide the participants with information regarding the rewards program, financial devices, financial services source 204, as well as family management and real estate, amongst others.

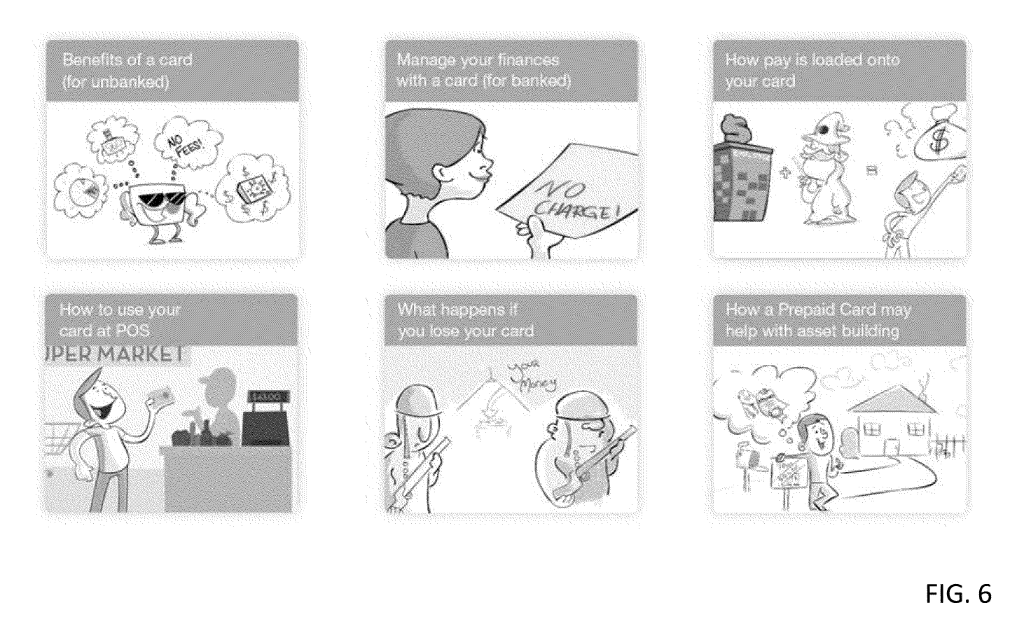

The various educational modules may be accessible through the educational panel 518 of the rewards dashboard and may be provided to the participant for his or her selection. In one preferred embodiment depicted in FIG. 6, various educational modules are provided to the participant in the form of titled cartoons. The user interface provided to a participant may also indicate what educational modules the participant has previously completed.

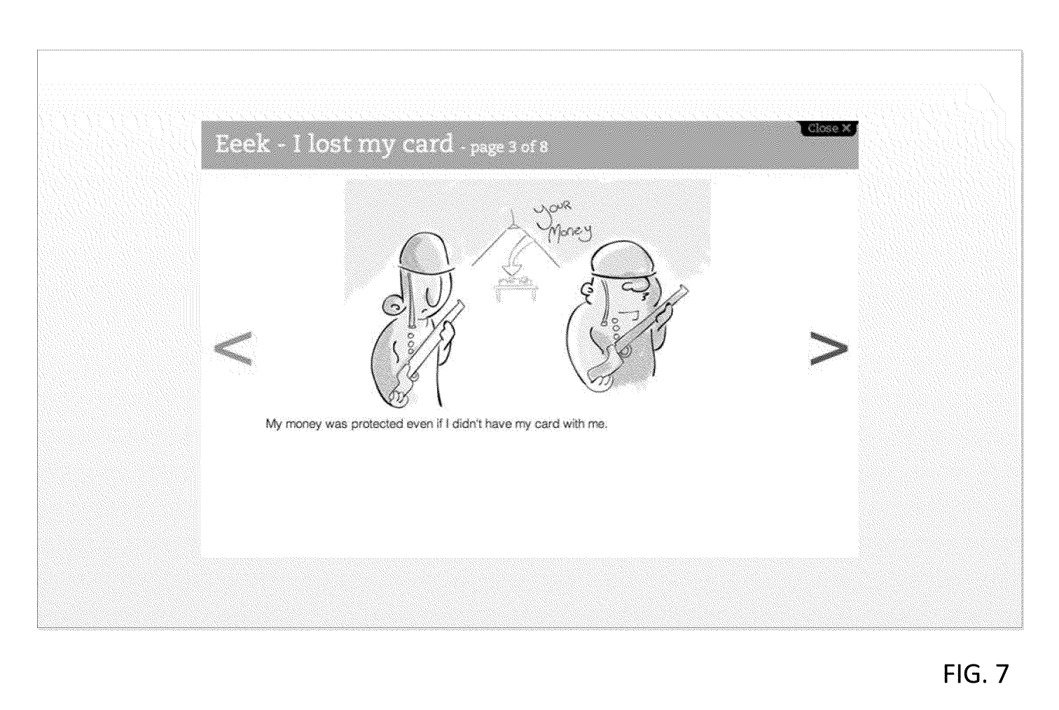

Upon the participant's selection of a particular educational module for which he or she is interested in learning, the participant may be taught by way of text, graphics, video, audio or any combination thereof. An exemplary user interface of the educational program provided to the participant is depicted on FIG. 7. Participants may be shown a series of educational cartoons that may contain accompanying text teaching the participant about the topic. In this case, the participant is shown that even after he or she loses the card, the money in the account associated with the card is protected and not lost. The use of stories and cartoons may help maintain the participant's participation and interest and may also provide entertainment at the same time.

In other embodiments, rather than a series of graphics, a video is displayed or audio cast is provided to the participant. The participant may also participate in a live interactive session with an instructor using video conferencing technology. The participant may ask questions, make comments and otherwise interact with the instructor and with other participants. In one embodiment, the participant may interact with the instructor using various user interface features, which may be generated by an interface engine. The instructor may distribute points to participants for their attendance, for asking or answering questions, for participation, and others.

In yet another embodiment of the present invention, the participant may be provided access to a game that teach the participant important tips, tools and various lessons through play. Games may be provided that place a fictional character under the control of the participant where the fictional character is placed in a situation or scenario that a participant may find him or herself. The game may provide participants with tips and guidance as to how to control the character towards a favorable solution. In one exemplary game, a participant may control a fictional character who has lost his or her prepaid debit card and the participant must maneuver the character through the adventure to find the character's prepaid card through which the participant may learn how to retrieve lost funds by avoiding fictional thieves, how to register the debit card, and so on. In another embodiment, participants may participate in a game in which participants compete against one another. In one game, participants compete by answering questions related to the educational programs similar to a game show. Participants may wager their own points against other participants. The number of points that the participant may receive from playing the games may vary based on the participant's performance in the game as well. In yet another embodiment, rewards management systems may integrate with external or third-party gaming systems to allow participants to connect to these external systems to play games and earn additional points.

By participating in an educational program, the participant may automatically receive a number of points. Further, a participant may receive additional points by participating in a quiz or may not receive points from the educational programs at all until the participant takes the quiz. This may be an effective measure to ensure that the participant learns from the educational program. The quiz may ask questions about the information explained in the educational program and the participant may be required to correctly answer a particular number of questions before receiving any points. The participant may also receive a number of points for each question that he or she gets correct or may be required to get all of the questions correctly before receiving points. Various other methods of rewarding points for taking part in an educational program may be utilized, including awarding points for completing not only particular programs, but also curriculum of programs.

In order to incentivize the learning of the information, a participant, in one embodiment, may retake the quizzes multiple times until he or she gets all of the questions correct. In certain embodiments, the participant may be required to retake the quizzes from time to time to ensure that the participant has, in fact, learned the material. The participant may also receive points for later taking actions that were taught by the educational program.

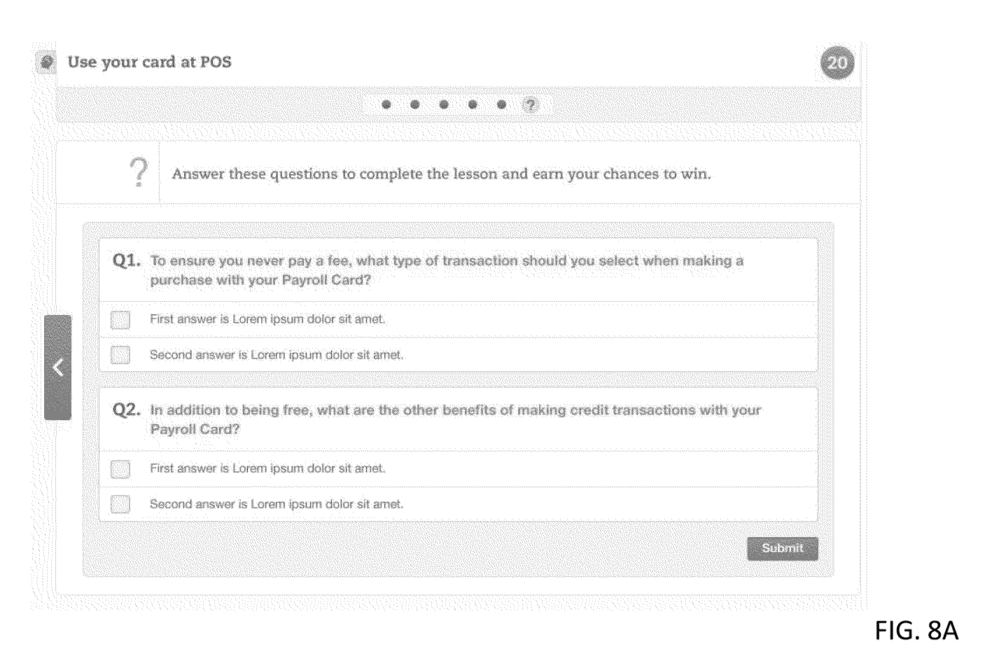

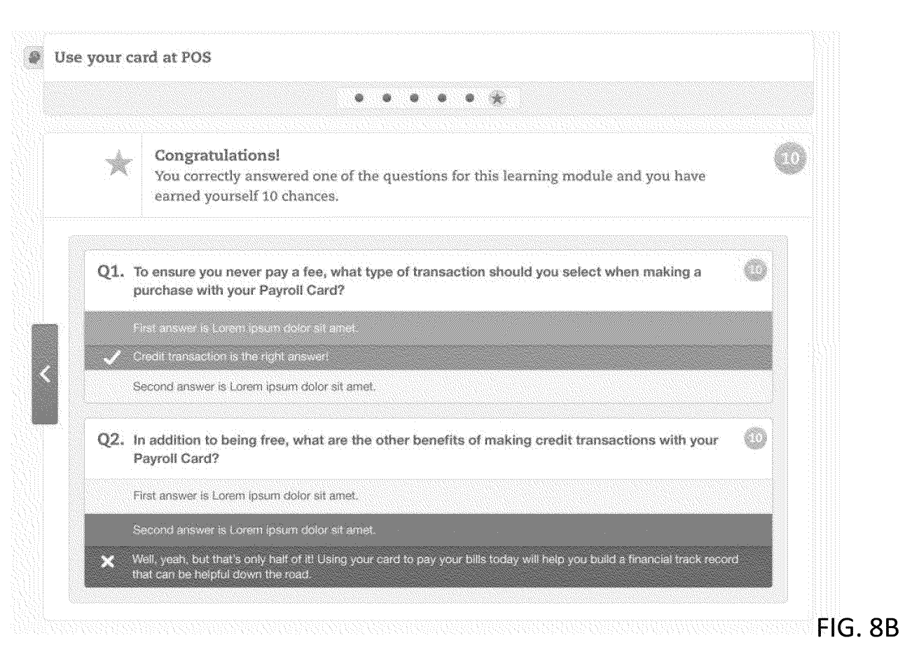

The participant may be shown a user interface as that shown on FIG. 8A in taking a quiz. The participant may answer various questions concerning a particular topic, such as what to do when one loses his credit, debit or prepaid card. He may be shown the results of his choices to the quiz, thereby allowing the participant to learn, even where he or she chooses the incorrect answer, as shown in FIG. 8B. After exiting, he may be given points for each correctly answered question.

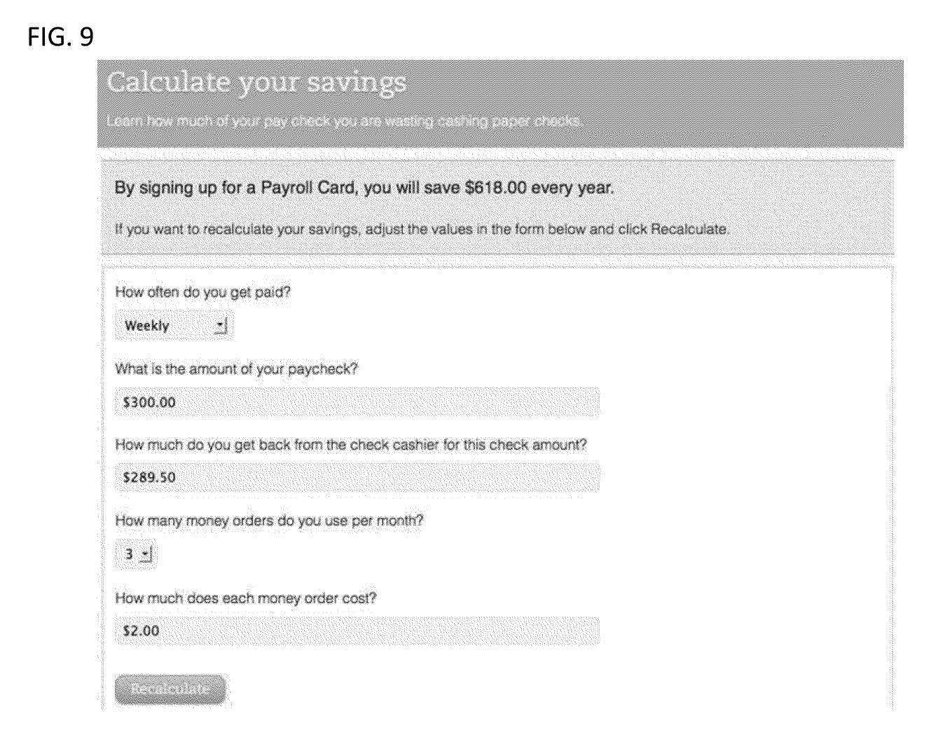

In addition to educational programs, the rewards management system may offer participants numerous other ways in which they may earn points through interacting with the rewards management system. These may be used as additional avenues in which participants may learn about financial management or aspects of the rewards program. Various tools may be provided to the participant to calculate and plan his finances. For example, a savings calculator may be offered in which a participant may determine how much money he or she is saving by using a prepaid debit card rather than cashing paper checks, as seen in FIG. 9. Another calculator may help the participant to determine how much he or she needs to save with each paycheck, each week, or each month in order to reach customizable financial goals. Yet another calculator may help the participant to determine how much and where he or she is spending his or her money. Other calculators may be provided that are directed towards other aspects such as personal health and career development. For example, a calculator may help customers with calculating the number of calories the participant has consumed or his or her body mass index. Another tool may help participants with creating and improving their resume. Providing such tools and incentives may help the participant learn to manage his or her money and may encourage the participant to improvement his or her behavior and lifestyle in various manners.

In certain embodiments of the presently disclosed invention, the participant may also earn points by referring the educational rewards program to family and friends. The rewards management system may allow the participant to send an email to a friend or family member encouraging them to join the program. As briefly discussed previously, a participant may also link his or her social networking accounts with his or her rewards program account. The rewards management system may allow participants to post an entry on the social networking accounts for others to see. For example, a participant may associate his or her rewards account with his or her Facebook™ account (or other social network account). He or she then may post an entry on his or her Facebook™ wall such that all of his or her friends and family may see that he or she has a rewards account. After a social networking account has been linked, an entry may be automatically posted on the social networking account each time the participant takes a certain action that qualifies him or her for points, such as his participation in an educational program.

Performing any of these sharing and referring actions may earn the participants a specific number of points. A sharing user interface may allow a participant to invite his or her friends and family, link his or her Facebook™ account, and post to his or her wall. The interface may further show the participant's history of sharing. Just as in other actions, more points may be given for inviting even more participants. For example, users may earn recurring points (monthly; weekly; annually) simply for linking their social media accounts with the participant's rewards account. In addition, in certain embodiments, participants may continue to receive additional points for actions of those participants he or she may have invited in the past. Thus, even after an invited participant joins, the inviter may continue to receive points each time the invited participant deposits money into his or her account, for example.

Referring again to FIG. 3, the action and reward center 312 may automatically detect the completion of the educational programs or the use of the various tools described herein and may automatically credit the participant's account with the corresponding credits.

Apart from interacting with the rewards management system 300, participants may also receive points for various transactions. Examples of qualifying transactions include, but are not limited to: depositing money into an account; reactivating an account; keeping an account active for a period of time; making a point of sale transaction; paying bills with the account; using the account to purchase essential items such as gasoline or groceries; completing a sales transaction with a new retailer, location or source; completing a transaction with specific or sponsoring merchants; making a transaction that is signature-based rather than PIN-based; making a transaction using a local or regional network rather than a national network (or vice versa); and other types of transactions that are to be rewarded.

An administrator may configure the actions that are rewardable and the corresponding points that participants may receive for performing such actions. As one example, an administrator may configure the rewards program such that participants may receive 5 points for making 1 or more point of sale transactions per week, 25 points for more than three point of sale transactions, and 50 points for making 50 point of sale transactions. Similarly, the rewards program may be configured such that participants may receive 30 points for paying each participant's bill, 50 points for each new place in which the card is used, or double points for shopping at a particular merchant. Further, a participant may lose 20 points for each time the participant withdraws from an ATM.

Embodiments of the present invention may include a rewards system that includes the award of positive points as well as negative points. A participant may be deducted points for certain transactions such as withdrawing cash from the account associated with the financial products or making a PIN-based transaction. Furthermore, in some embodiments, participants may receive a greater amount of points for making a higher quantity of particular transactions during a period. Thus, participants may be rewarded points based on the number of transactions rather than the size of the transactions, thereby further incentivizing them to use the financial products rather than use cash, checks, money orders, or other methods of payments. Such a method of rewarding participants does not leave low to middle-income participants at a disadvantage simply because he or she earns less money. Other embodiments of the presently disclosed invention may also incentivize use by awarding a greater amount of points for loyalty and longevity with the rewards program. For instance, participants may receive 50 points each time that money is loaded into a card and 500 points when the participant reactivates the card or keeps his rewards account active for more than 8 months.

Embodiments of the present invention may automatically detect when a participant performs rewardable actions by automatically detecting the completion of such transactions. In a preferred embodiment, the action and reward engine 312 may automatically detect such transactions at one or more transaction service sources or point of sale systems. The rewards management system 300 may intermittently connect to a financial services source of each participant to determine whether the participant has any additional transactions that may qualify the participant for additional points. The rewards management system 300 may check and download new transactions every time the participant connects to the rewards management system 300. In one preferred embodiment, the rewards management system 300 downloads transaction information in detail including the amount spent, the source, and the type of each transaction. In another embodiment, only some of the details of the transactions are downloaded. This may be done to protect the privacy of the participant.

The action and reward engine 312 may be configured to simply receive transaction and action updates from various computer systems that have been configured to provide the rewards management system with such information. Thus, a financial services source may automatically transmit the transactions information to the rewards management system 300 at predetermined times. A bank may be configured to automatically provide the rewards management system 300 with a notification of a participant transaction and may automatically transmit the information as soon as the transaction is completed at the point of sale system. In yet another embodiment, transaction information is automatically transmitted from the point of sale system to the rewards management system 300. Various notification and messaging systems may be utilized. Indeed, in at least one embodiment, the action and reward engine 312 includes various data and system adapters, allowing the action and reward engine to communicate with any number of systems with varying data structure and operational architectures.

Where the rewardable actions are not financial transaction related, the action and reward center 312 may be further configured to detect the completion of such actions by interacting with various other systems. For example, the action and reward engine 312 may automatically communicate with a social networking system to detect that the participant has posted a social networking link regarding the participant participating in the rewards program.

Whether a transaction qualifies a participant for points may vary from account to account and from rewards program to rewards program and may be configurable by the administrator engine 320. An administrator, who may be associated with a financial services source, a participating organization, a card issuer, or other organization, may customize whether a particular type of transaction may qualify for points and if so, how many points.

The action and rewards engine 312 may automatically and dynamically determine the number of points that may be provided to participants and the actions that are rewardable, taking into consideration the goals of the participants and/or the particular rewards program. Further, the action and rewards engine 312 may take into consideration the interests of the participants, rewards history, action history, account type, and/or other data. For example, given participants who have indicated in a survey that they are unfamiliar with the protection features of their prepaid cards, the action and rewards engine 312 may reward these participants with points (or more points) for participating in an educational program related to the protection features and initializing such features in their cards. As another example, the action and rewards engine 312 may reduce the number of points that are awarded for actions that have been rewarded 10 times in the last week (e.g., buying groceries), while increase the number of rewardable points for actions that are rarely taken by the participant (e.g., dining out at a healthy restaurant). Thus, the action and rewards engine 312 may be configured to dynamically adjust rewardable points and rewardable actions for each participant in order to induce additional learning and encourage more desirable and constructive actions.

Using the points earned from various rewardable actions, participants may participate in one or more sweepstakes, which may take place at the end of any configurable sweepstakes periods. In a preferred embodiment, each point that a participant earns may represent one chance of winning a prize. Thus, for example, where there are 200 participating participants with one point each, each participant has a one out of 200 chance of winning the prize in a sweepstakes drawing. Alternatively, each point may represent multiple chances for winning a prize and may vary based on the participant, the participant's account, the participant's organization and any other attributes. Furthermore, each sweepstake may be configured to be among any type or number of participants. For example, weekly sweepstakes may be configured to be among only employees of the same organization while monthly sweepstakes may include every participant participating in all rewards programs supported by the rewards management system 300.

The drawing may occur intermittently, such as every day, every week, and so on, as customizable by an administrator. The game engine 316 may collect the points that are at play at the expiration of the sweepstakes period and may choose a winner of a prize based on any number of selection algorithms. The game engine 316 may choose a winner at a completely random basis or may perform the selection using one or more weight-based algorithms. The selection algorithms may be customized so as to encourage greater participation in the rewards program, such as by rewarding new or returning participants or rewarding more active participants.

Furthermore, there may be multiple sweepstakes drawings active at the same time and points may qualify a participant to win multiple sweepstakes (e.g., points may qualify participants to win prizes from a weekly sweepstakes drawing and a monthly sweepstakes drawing). In addition, multiple prizes may be won in any one sweepstakes drawing. For instance, a sweepstakes drawing may have a $1,000 first-place prize, a $50 second-place prize, a $10 third-place prize, and so on. The user interface encourages the participant to earn more points through various methods and thereby to improve his or her chances of winning.

Moreover, in some sweepstakes actual merchandise may be won such as a car, concert tickets, or a coffee mug. In certain embodiments, points may be won as a prize. The prizes of a sweepstakes drawing may vary from period to period and may also change or improve based on the number of points that have been earned in that period by all participating participants. Thus, where participants in a particular week earned an above average or an inordinate number of points, then the prize in that week's drawing may be larger than average and may increase as the number of points increase. In certain cases, certain drawings may be large regardless of the number of points at stake in order to encourage actions by participants to earn additional points.

Participants may also qualify for drawings with better prizes by earning a certain number of points in a period. For example, participants that have earned over a particular points threshold in a given period may participate in an exclusive sweepstakes against one another, increasing the participating participants' chances of winning even better prizes.

In one embodiment of the presently disclosed invention, points are not automatically used in the active sweepstakes drawing. Rather, points may be submitted (i.e., played) in any future sweepstakes drawings as desired by the participant. Each participant may select how many points are to be applied into each sweepstakes, on what dates or periods. In one embodiment, a participant may configure his or her account to automatically distribute his or her points based on any number of predefined rules. In one embodiment, participants may also use these points to redeem guaranteed prizes. These prizes, in most cases, are valued much less than the sweepstakes prizes. Any other forms of prizes may be provided to a winner, such as tickets to special events, access to or association with a level of participant status (e.g., participant social group association), access to special or fee-required educational programs, or other exclusive events, programs, locations, points, and other prizes.

In certain instances, participants who have joined the rewards program may not be eligible to win prizes in sweepstakes until the participant has taken certain actions. For example, a participant may not be eligible to win prizes until he has activated his prepaid card associated with his rewards account. Upon activation, he or she may then be eligible to win prizes. In these cases, the participant may accrue points by participating in any of the educational programs or using any of the tools previously described. Upon activation of his or her card, the points may then be used for the active sweepstakes drawing.

After a winner is chosen, the game engine 316 may notify the participant and deliver the prize automatically to the participant. The game engine 316, for example, may automatically add the cash winnings to a winner participant's associated financial account. This may be done by transmitting an electronic money transfer request to a financial services source. For example, where the financial product is a prepaid card, the game engine 316 may automatically cause the transmittal of the prize amount to the account associated with the prepaid card. The game engine 316 may communicate with a financial service source to cause the transfer of the prize accordingly. This feature may encourage the use of the card and the use of the rewards program. However, the participant may have the option to receive his prizes through other forms such as by check, money order, or cash. Where the prize is merchandise, the item may be delivered to the participant.

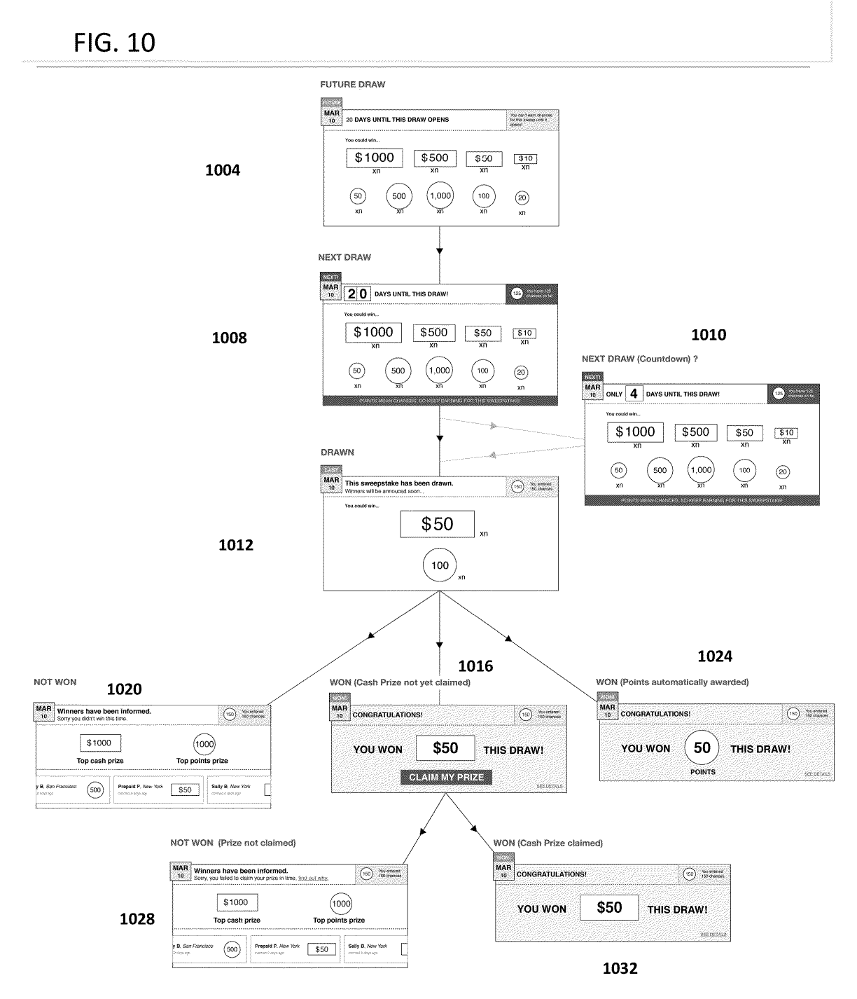

FIG. 10 depicts a flowchart of user-interfaces that may be shown to a particular provider as he or she enters points for a sweepstakes to the results of the sweepstakes being determined. As illustrated in user interface 1004, a participant may enter a sweepstakes that is set to be drawn some time in the future. The participant may be shown a user interface that shows the prizes and may detail the prizes that are available based on the number of chances that are entered. For example, if a participant enters 1000 points for a particular sweepstakes, the participant may have a chance to win $1,000. In contrast, a participant who only enters 150 points into a particular sweepstakes may only eligible to win up to $500. In the scenario where a user needs to ‘play’ their points in order for them to count toward a prize, some prizes may require a large number of points in order to participate which may preclude some users from entering certain sweepstakes.

As depicted in user interface 1008, the participant may be allowed to enter the drawing because he or she has accumulated the minimum number of points for entry or the date in which the sweepstakes would open is reached. In an embodiment, sweepstakes may not open until 15 days before the drawing is set to begin. This may create excitement among the participants and force participants to access the rewards program more often, especially as dates for sweepstakes draw near. With user interface 1010 for example, the countdown timer may be adjusted accordingly to further create excitement.

The game engine 316 may be initialized to complete a drawing. A winner may be determined but not announced until a predetermined time period after the drawing, as depicted in user interface 1012. The participant may be asked to check back and may be induced to check back at a later time by providing the participant with his or her potential winnings.

As shown in user interface 1016, the winner may be announced and in this case, a particular participant may be told that he or she has won $50. If the participant has not won, the participant may be shown user interface 1012, in which the participant is told that he or she is not the winner and that the winner has been informed.

The participant may immediately redeem the prize if he or she has won. To redeem, the participant may enter his or her information including name, phone number, and address. Such information may automatically be retrieved from the database 320 for the participant based on his or her registration information. The participant may be required to further enter his or her social security number if the prize is over a particular amount or the participant has won over a set amount in a particular period, as may be required by laws of the jurisdiction in which the participant resides or the game is conducted. Upon redemption, the participant may be shown user interface 1032. In certain embodiments, participant may be required to redeem a winning prize within a time limit. Failure to do so may result in the forfeiting of the prize, as shown in the user interface 1028. Instead of a prize, participants may receive additional points. Such points may be automatically added to the participant's rewards account, as shown in user interface 1024.

The components shown in the attached figures may be or include a computer or multiple computers. The components may be described in the general context of computer-executable instructions, such as program modules, being executed by a computer. Generally, program modules include routines, programs, objects, components, data structures, etc., that perform particular tasks or implement particular abstract data types.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system or platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, PHP, Prolog, Python, RUM and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each processor and/or memory may be composed of different physical pieces of equipment.

A participant may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a participant input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN), and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the participant-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocols. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

While particular embodiments of the invention have been illustrated and described in detail herein, it should be understood that various changes and modifications might be made to the invention without departing from the scope and intent of the invention.

From the foregoing, it will be seen that this invention is one well adapted to attain all the ends and objects set forth above, together with other advantages, which are obvious and inherent to the systems and methods. It will be understood that certain features and sub-combinations are of utility and may be employed without reference to other features and sub-combinations. This is contemplated and within the scope of the invention.

What is claimed is:

1. A system for providing a rewards program for a plurality of rewards accounts, the system comprising:
a processor;
at least one storage device coupled to the processor; and
a user interface coupled to the processor via one or more communication networks;
wherein the processor is adapted to communicate with the at least one storage device and the user interface to execute instructions to perform the following:
associating a financial product with a rewards account of the plurality of rewards accounts;
establishing at least one sweepstakes drawing;
receiving a rewardable action associated with the financial product associated with the rewards account;
associating one or more units of chance with the rewards accounts in response to the receiving of a rewardable action;
executing the at least one sweepstakes drawing by selecting at least one winning unit of chance from a pool of units of chances associated with the plurality of rewards accounts; and
providing a prize to the rewards account associated with the at least one winning unit of chance.

2. The system of claim 1, wherein the rewardable action is a participation in an educational program, the system further configured to provide an educational program.

3. The method of claim 2, wherein the educational program relates to at least one of:
features of the financial product;
features of the rewards program;
financial responsibility;
asset building;
shopping;
health and nutrition;
professional development;
family management; and
real estate.

4. The system of claim 2, wherein the educational program includes at least one of illustrated art, a video clip, a video-conference, an audiocast.

5. The system of claim 2, wherein the system is further configured to associate a second one or more units of chance with the rewards accounts in response to a second rewardable action, wherein the second rewardable action is a completion of a questionnaire related to the educational program provided.

6. The system of claim 2, wherein the system is further configured to associate a second one or more units of chance with the rewards accounts in response to a second rewardable action, wherein the second rewardable action is described by the educational program provided.

7. The system of claim 1, wherein the financial product is one of a debit card, credit card, and prepaid card.

8. The system of claim 1, wherein the associating the financial product with a rewards account is based on one or more activation codes.

9. The system of claim 1, the system further configured to automatically detect the rewardable action at a point of sale system or a financial services system.

10. The system of claim 1, wherein the rewardable action is a transaction completed using the financial product.

11. The system of claim 1, wherein the rewardable actions includes at least one of:
depositing money into an account associated with the financial product;
reactivating the rewards account;
keeping the rewards account active for an extended period of time;
completing a point of sale transaction with the financial product;
paying a bill with the financial product;
purchasing an essential item with the financial product;
completing a sales transaction with a new retailer, location or source with the financial product;
completing a transaction with a predetermined merchant with the financial product; and
making a signature-based transaction with the financial product.

12. The system of claim 1, the system being further configured to un-associate one or more units of chance with the one or more rewards accounts based on negative actions taken by the participant of the rewards account.

13. A method for providing a rewards program for a plurality of rewards accounts, the method comprising:
associating a financial product with a rewards account of the plurality of rewards accounts;
establishing at least one sweepstakes drawing;
receiving a rewardable action associated with the financial product associated with the rewards account;
associating one or more units of chance with the rewards accounts in response to the receiving of a rewardable action;
executing the at least one sweepstakes drawing by selecting at least one winning unit of chance from a pool of units of chances associated with the plurality of rewards accounts; and
providing a prize to the rewards account associated with the at least one winning unit of chance.

14. The method of claim 13, wherein the rewardable action is a participation in an educational program, the method further comprising the step of providing an educational program.

15. The method of claim 14, wherein the educational program relates to at least one of:
features of the financial product;
features of the rewards program;
financial responsibility;
health and nutrition;
professional development;
asset building;
shopping;
family management; and
real estate.

16. The method of claim 14, wherein the educational program includes at least one of illustrated art, a video clip, a video-conference, an audiocast.

17. The method of claim 14, further comprising the step of associating a second one or more units of chance with the rewards accounts in response to a second rewardable action, wherein the second rewardable action is a completion of a questionnaire related to the educational program provided.

18. The method of claim 14, further comprising the step of associating a second one or more units of chance with the rewards accounts in response to a second rewardable action, wherein the second rewardable action is described by the educational program provided.

19. The method of claim 13, wherein the financial product is one of a debit card, credit card, and prepaid card.

20. The method of claim 13, wherein the step of associating the one or more financial products with a rewards account is based on one or more activation codes.

21. The method of claim 13, further comprising the step of automatically detecting the rewardable action at a point of sale system or a financial services system.

22. The method of claim 13, wherein the rewardable action is a transaction completed using the one or more financial products.

23. The method of claim 13, wherein the rewardable actions includes at least one of:
depositing money into an account associated with the financial product;
reactivating the rewards account;
keeping the rewards account active for an extended period of time;
making a point of sale transaction with the financial product;
paying a bill with the financial product;
purchasing an essential item with the financial product;
completing a sales transaction with a new retailer, location or source with the financial product;
completing a transaction with a predetermined merchant with the financial product; and
completing a signature-based transaction with the financial product.

24. The method of claim 13, further comprising the steps of un-associating one or more units of chance with the one or more rewards accounts based on negative actions taken by the participant of the rewards account.
